(19) United States
(12) Patent Application Publication
(10) Pub. No.: US 2013/0014734 A1
(43) Pub. Date: Jan. 17, 2013

(54) METHOD FOR OPERATING AN EGR COOLER IN AN INTERNAL COMBUSTION ENGINE

(71) Applicants: Simone BARBERO, Torino (IT); Douglas TROMBLEY, Torino (IT); Francesco CIANFLONE, Torino (IT); Giovanni MONTINARO, San Pietro Vernotico (BR) (IT)

(72) Inventors: Simone BARBERO, Torino (IT); Douglas TROMBLEY, Torino (IT); Francesco CIANFLONE, Torino (IT); Giovanni MONTINARO, San Pietro Vernotico (BR) (IT)

(73) Assignee: GM GLOBAL TECHNOLOGY OPERATIONS LLC., Detroit, MI (US)

(21) Appl. No.: 13/545,090

(22) Filed: Jul. 10, 2012

(30) Foreign Application Priority Data
Jul. 11, 2011 (GB) 1111820.5

(51) Int. Cl. F02B 47/10; F02M 25/07

(52) U.S. Cl. 123/568.16; 123/568.12; 701/108

(57) ABSTRACT

A method for operating an EGR system in an Internal Combustion Engine (ICE) is provided. The EGR system includes an EGR valve for regulating an exhaust gas flow into an EGR cooler and a by-pass line for by-passing the EGR cooler. The method includes monitoring an index value indicative of a clogging condition of the EGR cooler, closing the exhaust gas flow in the EGR cooler if the index value exceeds a predefined threshold, and opening the exhaust gas flow in the EGR cooler if the index value is decreasing.

### CROSS-REFERENCE TO RELATED APPLICATION

This application claims priority to British Patent Application No. 1111820.5, filed Jul. 11, 2011, which is incorporated herein by reference in its entirety.

### TECHNICAL FIELD

The present disclosure relates to a method for operating an EGR cooler in an Internal Combustion Engine.

### BACKGROUND

Internal combustion engines may include an exhaust gas recirculation (EGR) system coupled between an exhaust manifold and an intake manifold of the engine. With this system, a portion of the exhaust gas of the engine is recirculated to the engine. The lower combustion chamber temperatures caused by the EGR system reduce the amount of NOx the combustion generates.

The EGR system may include an EGR cooler to reduce the temperature of the exhaust gases in the EGR system. An EGR valve regulates a flow of exhaust gases in the EGR system. An EGR bypass conduit having an EGR by-pass valve may be provided for bypassing the EGR cooler.

An EGR cooler is a heat exchanger suitable to transfer heat from the exhaust gas of the engine to a cooling fluid, such as water with an antifreeze component circulating in a cooling circuit of the engine, in order to reduce the temperature of the exhaust gas that are recirculated into the engine.

A problem that may arise in the EGR cooler, especially at low temperatures, is that Hydrocarbons (HC) contained in the exhaust gas flow of the engine may condensate on the cooler walls. Since exhaust gas flow contains also particulate matter, this particulate may accumulate to the wet walls of the EGR cooler and progressively clog the EGR cooler.

At least one object of an embodiment herein is to provide a method for protecting the EGR cooler in an Internal Combustion Engine against clogging.

A further object of an embodiment herein is to provide a method for operating an EGR cooler that allows the implementation of engine architectures that include exhaust gas recirculated at low temperature, that lower the engine NOx and CO2 emissions, avoiding the risk of clogging the cooler because of high amount of Hydrocarbons (HC) and soot accumulated inside.

Another object herein is to provide a protection against clogging of the EGR cooler without using complex devices and by taking advantage from the computational capabilities of the Electronic Control Unit (ECU) of the vehicle. In addition, other objects, desirable features and characteristics will become apparent from the subsequent summary and detailed description, and the appended claims, taken in conjunction with the accompanying drawings and this background.

### SUMMARY

An embodiment of the disclosure provides for a method for operating an EGR system in an Internal Combustion Engine, the EGR system comprising an EGR valve for regulating an exhaust gas flow into an EGR cooler, and a by-pass line for by-passing the EGR cooler, the method providing for:
a phase of monitoring a value of an index indicative of a clogging condition of the EGR cooler,
a phase of closing the exhaust gas flow in the EGR cooler, if the index value exceeds a predefined threshold, and
a phase of opening the exhaust gas flow in the EGR cooler, if the if the index value is decreasing.

This method may be applied to different engine architectures that include exhaust gas recirculation at a low temperature, for lowering engine NOx and CO2 emissions, avoiding the risk of clogging the EGR cooler with accumulated soot.

Furthermore, an index value may be easily implemented in the Electronic Control Unit (ECU) of the vehicle, for example using a counter value. The index value represents an approximate measure of the state of the EGR cooler clogging

According to a further embodiment, the phase of closing the exhaust gas flow in the EGR cooler is actuated by closing the EGR valve.

According to a another embodiment, the phase of closing the exhaust gas flow in the EGR cooler is actuated by by-passing the EGR cooler.

An advantage of these embodiments is that they use devices already present on current production vehicles.

According to still another embodiment, the index value is incremented by an index increasing value when all of the following conditions are met:
the engine load is lower than a load threshold dependent on engine speed and engine coolant temperature;
the engine coolant temperature is lower than a threshold, or an engine thermostatic valve is closed, or the coolant temperature in the EGR cooler is estimated to be lower than a threshold,
the EGR valve is open, and
the EGR cooler is not bypassed.

These conditions are chosen to represent operating conditions of the engine and of the EGR cooler in which the engine works at a high soot production rate and at low temperatures of the EGR coolant that cause wet Hydrocarbon (HC) condensation on EGR cooler walls; in this case the index value is therefore incremented to keep track of the amount time the EGR systems spends in these conditions.

Another embodiment provides a method in which the index value is maintained at a constant value when at least one of the following conditions are met:
the engine is stopped,
the EGR cooler is bypassed,
the EGR valve is closed.

In this regard, conditions are taken into account in which there are no significant variations in the clogging status of the EGR cooler.

According to a further embodiment, the index value is decreased by an index decreasing value when all of the following conditions are met:
the EGR valve is requested to be opened,
the EGR cooler bypass is requested not to be bypassed, and at least one of the following conditions is met:
the engine load is higher than a load threshold, dependent on engine speed and engine coolant temperature, and
the engine coolant temperature is higher than a threshold, or an engine thermostatic valve is open.

These conditions are chosen to represent operating conditions of the engine and of the EGR cooler in which the engine works at a low soot production rate and at the high temperatures of the EGR coolant that facilitate Hydrocarbon (HC) evaporation from EGR cooler walls.

According to a further embodiment, the exhaust gas flow in the EGR cooler is closed if the conditions to decrease the index value are no more fulfilled, but the index value is still higher than a critical threshold.

An advantage of this embodiment is that it defines a sub-condition that avoids operating the EGR circuit when clogging conditions in the EGR cooler are still above a critical threshold.

Also provided is an apparatus for operating an EGR system in an Internal Combustion Engine, the EGR system comprising an EGR valve for regulating an exhaust gas flow into an EGR cooler, and a by-pass line for by-passing the EGR cooler, the apparatus comprising:
means for monitoring an index indicative of a clogging condition of the EGR cooler,
means for closing the exhaust gas flow in the EGR cooler, if the index value exceeds a predefined threshold, and
means for opening the exhaust gas flow in the EGR cooler, if the index value is decreasing.

In addition, an automotive system comprising an internal combustion engine equipped with an EGR system is provided. The EGR system comprises an EGR valve for regulating an exhaust gas flow into an EGR cooler, and a by-pass line for by-passing the EGR cooler. The automotive system comprises an electronic control unit configured for:
monitoring an index indicative of a clogging condition of the EGR cooler,
closing the exhaust gas flow in the EGR cooler, if the index value exceeds a predefined threshold, and
opening the exhaust gas flow in the EGR cooler, if the index value is decreasing.

The method according to an embodiment can be carried out with the help of a computer program comprising a program-code for carrying out all the steps of the method described above, and in the form of computer program product comprising the computer program.

The computer program product can be embodied as a control apparatus for an internal combustion engine, comprising an Electronic Control Unit (ECU), a data carrier associated to the ECU, and the computer program stored in a data carrier, so that the control apparatus defines the embodiments described in the same way as the method. In this case, when the control apparatus executes the computer program all the steps of the method described above are carried out.

The method according to a further embodiment can be also embodied as an electromagnetic signal, the signal being modulated to carry a sequence of data bits which represents a computer program to carry out all steps of the method.

A still further embodiment provides an internal combustion engine specially arranged for carrying out the method claimed.

### BRIEF DESCRIPTION OF THE DRAWINGS

The various embodiments will hereinafter be described in conjunction with the following drawing figures, wherein like numerals denote like elements, and wherein:

FIG. 1 shows an automotive system;

FIG. 2 is a cross-sectional view of an internal combustion engine belonging to the automotive system of FIG. 1;

FIG. 3 is a schematic representation of a first EGR cooling circuit for an automotive system and in which an embodiment may be implemented;

FIG. 4 is a schematic representation of a second EGR cooling circuit in which an embodiment may be implemented;

FIG. 5 is a flowchart of an EGR operating strategy according to one embodiment; and

FIG. 6 is a graph representative of EGR events determined according to an embodiment.

### DETAILED DESCRIPTION

The following detailed description is merely exemplary in nature and is not intended to limit the various embodiments or the application and uses thereof. Furthermore, there is no intention to be bound by any theory presented in the preceding background or the following detailed description.

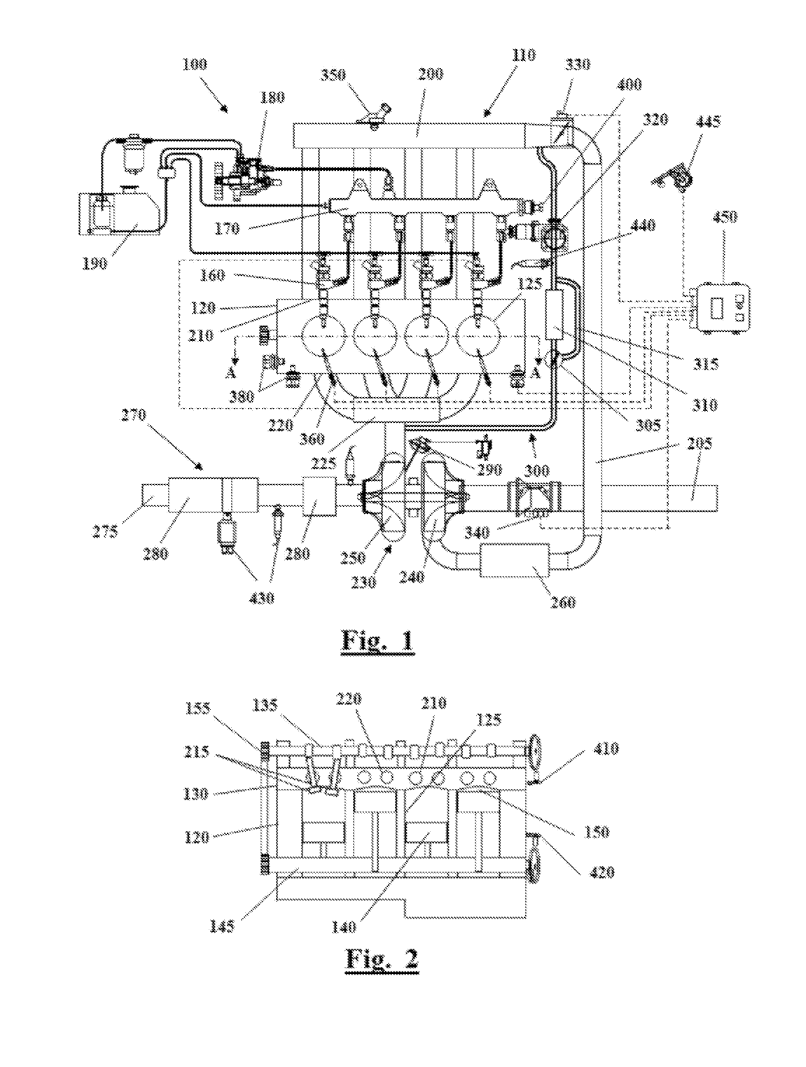

Various embodiments contemplated herein include an automotive system 100, as shown in FIGS. 1 and 2, that includes an internal combustion engine (ICE) 110 having an engine block 120 defining at least one cylinder 125 having a piston 140 coupled to rotate a crankshaft 145. A cylinder head 130 cooperates with the piston 140 to define a combustion chamber 150. A fuel and air mixture (not shown) is disposed in the combustion chamber 150 and ignited, resulting in hot expanding exhaust gasses causing reciprocal movement of the piston 140. The fuel is provided by one or more fuel injectors 160 and the air through one or more intake ports 210. The fuel is provided at high pressure to the fuel injector 160 from a fuel rail 170 in fluid communication with a high pressure fuel pump 180 that increase the pressure of the fuel received a fuel source 190. Each of the cylinders 125 has at least two valves 215, actuated by a camshaft 135 rotating in time with the crankshaft 145. The valves 215 selectively allow air into the combustion chamber 150 from the port 210 and alternately allow exhaust gases to exit through a port 220. In one embodiment, a cam phaser 155 selectively varies the timing between the camshaft 135 and the crankshaft 145.

The air may be distributed to the air intake port(s) 210 through an intake manifold 200. An air intake duct 205 may provide air from the ambient environment to the intake manifold 200. In an embodiment, a throttle body 330 is provided to regulate the flow of air into the manifold 200. In another embodiment, a forced air system such as a turbocharger 230, having a compressor 240 rotationally coupled to a turbine 250, is provided. Rotation of the compressor 240 increases the pressure and temperature of the air in the duct 205 and manifold 200. An intercooler 260 disposed in the duct 205 may reduce the temperature of the air. The turbine 250 rotates by receiving exhaust gases from an exhaust manifold 225 that directs exhaust gases from the exhaust ports 220 and through a series of vanes prior to expansion through the turbine 250. The exhaust gases exit the turbine 250 and are directed into an exhaust system 270. This embodiment shows a variable geometry turbine (VGT) with a VGT actuator 290 arranged to move the vanes to alter the flow of the exhaust gases through the turbine 250. In another embodiment, the turbocharger 230 is fixed geometry and/or includes a waste gate.

The exhaust system 270 may include an exhaust pipe 275 having one or more exhaust aftertreatment devices 280. The aftertreatment devices may be any device configured to change the composition of the exhaust gases. Some examples of aftertreatment devices 280 include, but are not limited to, catalytic converters (two and three way), oxidation catalysts, lean NOx traps, hydrocarbon adsorbers, selective catalytic reduction (SCR) systems, and particulate filters.

According to various embodiments, the automotive system 100 includes an exhaust gas recirculation (EGR) system 300 coupled between the exhaust manifold 225 and the intake manifold 200. The EGR system 300 may include an EGR cooler 310 to reduce the temperature of the exhaust gases in the EGR system 300 and a by-pass line 315 for by-passing the EGR cooler 310, the by-pass line 315 being selected by an EGR by-pass valve 305. An EGR valve 320 regulates a flow of exhaust gases in the EGR system 300.

The automotive system 100 may further include an electronic control unit (ECU) 450 in communication with one or more sensors and/or devices associated with the ICE 110. The ECU 450 may receive input signals from various sensors configured to generate the signals in proportion to various physical parameters associated with the ICE 110. The sensors include, but are not limited to, a mass airflow and temperature sensor 340, a manifold pressure and temperature sensor 350, a combustion pressure sensor 360, coolant and oil temperature and level sensors 380, a fuel rail pressure sensor 400, a cam position sensor 410, a crank position sensor 420, exhaust pressure and temperature sensors 430, an EGR temperature sensor 440, and an accelerator pedal position sensor 445. Furthermore, the ECU 450 may generate output signals to various control devices that are arranged to control the operation of the ICE 110, including, but not limited to, the fuel injectors 160, the throttle body 330, the EGR Valve 320, the VGT actuator 290, and the cam phaser 155. Note, dashed lines are used to indicate communication between the ECU 450 and the various sensors and devices, but some are omitted for clarity.

Turning now to the ECU 450, this apparatus may include a digital central processing unit (CPU) in communication with a memory system, or data carrier 460, and an interface bus. The CPU is configured to execute instructions stored as a program in the memory system, and send and receive signals to/from the interface bus. The memory system may include various storage types including optical storage, magnetic storage, solid state storage, and other non-volatile memory. The interface bus may be configured to send, receive, and modulate analog and/or digital signals to/from the various sensors and control devices. The program may embody the methods disclosed herein, allowing the CPU to carryout out the steps of such methods and control the ICE 110.

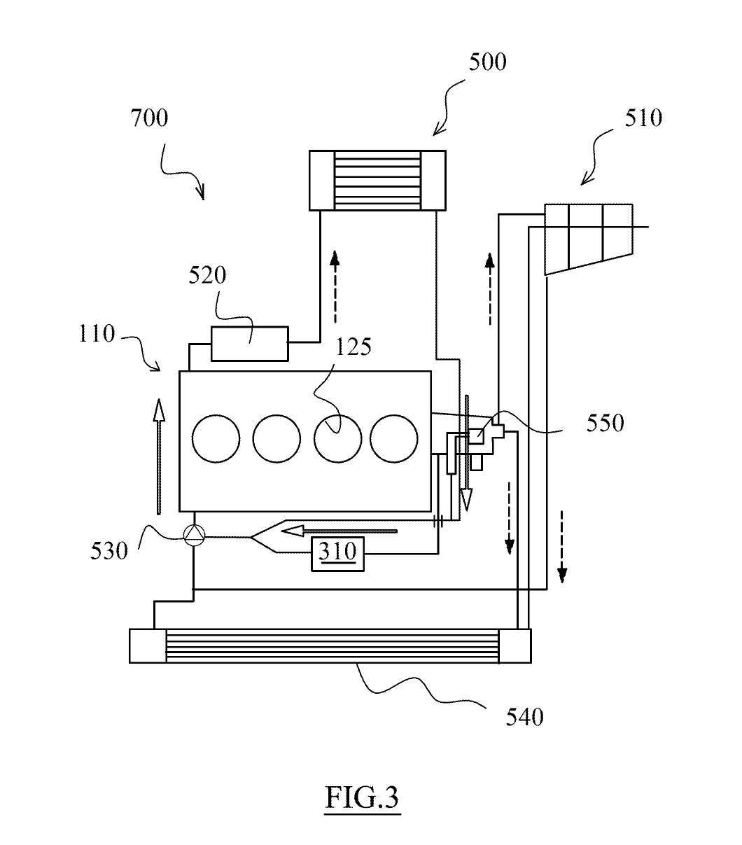

More specifically, FIG. 3 shows a schematic illustration of a first EGR cooling circuit 700 in which an embodiment may be implemented.

In circuit 700, a switchable water pump 530 makes a coolant fluid flow inside the engine 110 and in particular inside conduits in the engine block 120. The coolant fluid circulates therein exiting from the cylinder head 130, since the engine block 120 and the cylinder head 130 are equipped with a plurality of passageways cast or machined therein to allow the coolant fluid flow. The coolant fluid may be water with an antifreeze component.

The cooling circuit 700 is equipped with a radiator 540 and with a thermostatic valve 550 which has the function of limiting the cooling of the engine 110. For example, at start up, until the engine 110 has reached a temperature sufficiently high to allow normal operation, the thermostatic valve 550 closes temporarily the portion of the cooling circuit that allows coolant to flow through the radiator 540. The thermostatic valve 550 may be electrically controlled.

The coolant fluid also flows into an oil cooler 520 and into a heater core 500 and then back towards the engine 110 and the radiator 540.

A portion of the coolant is directed to a surge tank 510 that is used for the release of entrapped gas into the fluid. The degassed fluid is then recirculated back towards the engine 110.

A portion of the coolant flows through a radiator 540 to exchange heat with the external ambient air, while a portion flows through the EGR cooler 310 to reduce the temperature of the exhaust gases in the EGR system 300, since the heat of the recirculated exhaust gas is partially transferred to the cooling fluid before the exhaust gas reach the intake manifold 200.

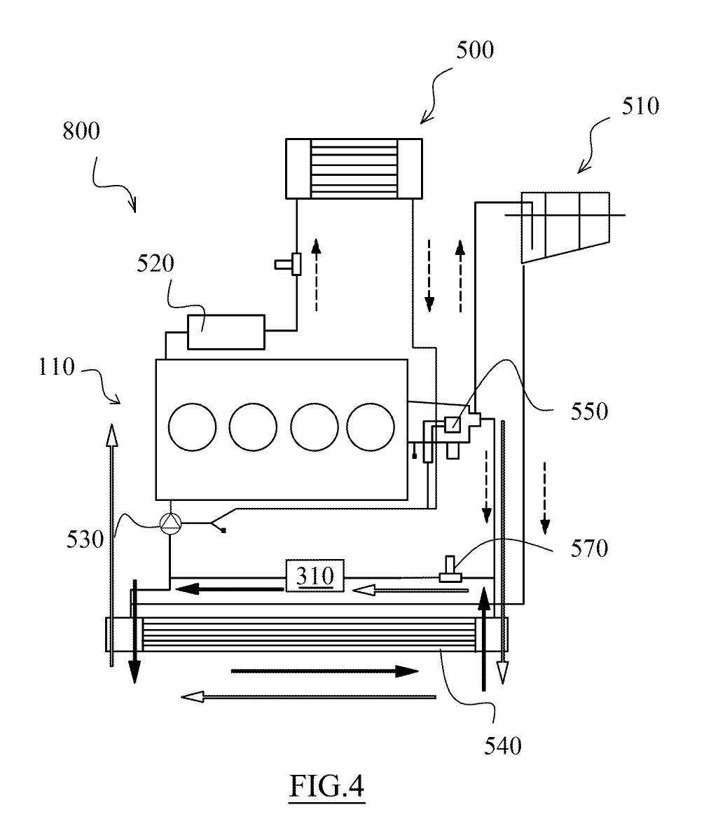

FIG. 4 shows a schematic illustration of a second EGR cooling circuit 800 in which an embodiment may be implemented.

In this case, the EGR cooler 310 is placed on a separate line and the coolant is fed into it by an auxiliary coolant pump 570.

The difference with respect to circuit 700 is that, in this case, exhaust gas is recirculated at low temperature; for example solid black arrows in a counterclockwise direction in FIG. 4 indicate a recirculation of cooling fluid at a temperature between 35° C. and 90° C. Low exhaust gas recirculation lowers the engine NOx and CO2 emissions and the method according various embodiments is particularly beneficial in avoiding the risk of clogging the EGR cooler 310, avoiding the accumulation inside the EGR cooler 310 of high amount of Hydrocarbons (HC) and soot.

Generally speaking, according to an embodiment, the EGR valve 320 is closed avoiding exhaust gas flow in the EGR system 300 circuit whenever the engine is detected working for long time:
at high soot production, at high Hydrocarbon (HC) production, or
at a low temperature of EGR coolant, namely a temperature that allows wet

Hydrocarbon (HC) condensation on the EGR cooler 310 walls.

As an alternative to the closure of the EGR valve 320, the EGR cooler 310 may be by-passed.

The EGR valve 320 shall be reopened when the engine 110 achieves conditions that allow Hydrocarbon (HC) evaporation from the EGR cooler 310 walls.

These conditions may be the following:
warm coolant temperature at EGR cooler 310 inlet for a long enough time, or
when conditions are sufficient to avoid and to remove soot deposits on EGR cooler 310 walls, or
high exhaust gas temperature and flow at EGR cooler 310 inlet for a long enough time.

The decision to modify the exhaust gas flow in the EGR system 300 can be achieved through an algorithm implemented in the electronic control unit (ECU) 450 according to following requirements: an EGR valve 320 shut off or an EGR cooler 310 by-pass is requested when an incremental index value C exceeds a calibratable threshold CMax, representative of an EGR cooler 310 clogging condition.

This index value C shall be incremented by an index increasing value X when all of the following conditions are met:
engine 110 load E_{load} is lower than a load threshold E_{load}_{_{—}}ₘₐₓ dependent on engine speed and coolant temperature;
engine 110 coolant temperature EC_{Temp} is lower than a temperature threshold EC_{Temp}_{_{—}}ₘₐₓ or the thermostatic valve 550 is closed, in case the thermostatic valve 550 is electrically controlled;
the EGR valve 320 is requested to be open,
the EGR cooler 310 is not bypassed and, if present, the auxiliary coolant pump 570 that feeds the EGR cooler 310, is running.

The index value C shall not be incremented (and therefore kept at the same value unless decreasing conditions are met) when at least one of the following conditions are met:
the engine 110 is stopped
the EGR cooler 310 is bypassed
the EGR valve 320 is closed.

The index value C is decreased by an index decreasing value Y when all of the following conditions are met:
the EGR valve 320 is opened
the EGR cooler bypass 315 is not bypassed, and at least one of the following conditions is met:
the engine 110 load E_{load} is higher than the engine load threshold E_{load}_{_{—}}ₘₐₓ dependent on engine speed and coolant temperature;
the engine 110 coolant temperature EGRCool_{Temp} is higher than a temperature threshold EGRCool_{Temp}_{_{—}}ₘₐₓ, or
the thermostatic valve 550 is open.

The index decreasing value Y may be different from the index increasing value X and they can be both calibratable values.

At an initial stage, the index value C is initialized at zero.

The lower limit of index value C value is zero.

If the index value C is saturated to its maximum value CMax, and then the EGR valve 320 is closed or the EGR cooler 310 is bypassed, for a time longer than a calibratable threshold Timethres, the customer is requested by suitable visual and/or acoustic means to move as soon as possible to driving conditions that can allow an EGR cooler 310 regeneration or to go to Service for executing there a similar procedure.

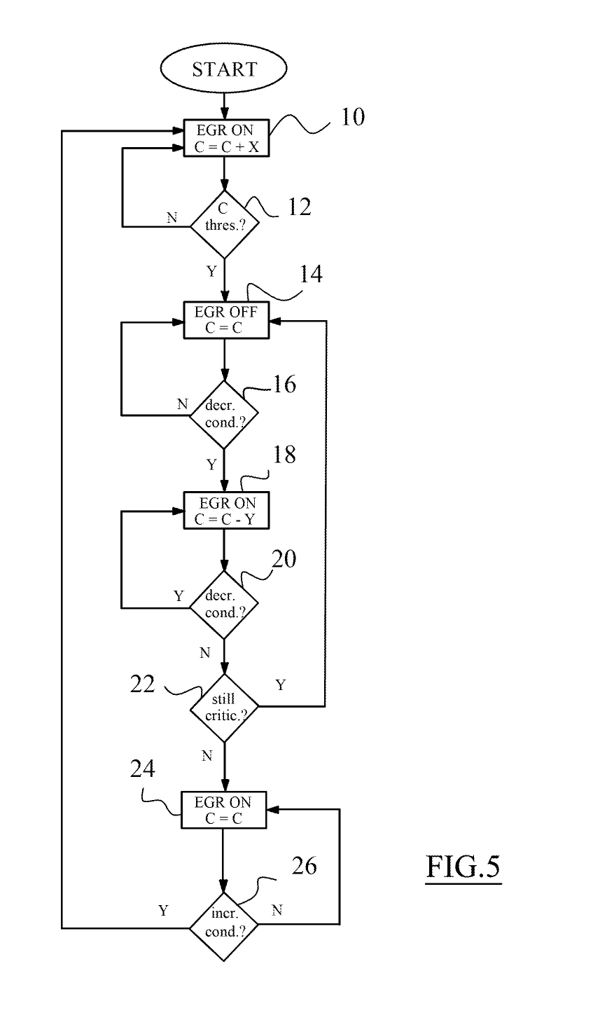

FIG. 5 is a flowchart of an EGR operating strategy according to one embodiment where, for the sake of simplicity, with EGR ON it is intended a condition in which the EGR valve 320 is open and with EGR OFF it is intended a condition in which the EGR valve 320 is closed or the EGR cooler 310 is by-passed.

At the start of the procedure, the EGR is ON and index C is incremented, if the above incrementing conditions are verified, by a quantity X (block 10), until (block 12) index value C reaches a CMax threshold representative of EGR clogging conditions reached.

When the clogging threshold CMax has been reached, EGR is OFF (block 14), namely the EGR valve 320 is closed or the EGR cooler 310 is by-passed.

At this stage, the index value C is kept at the same value, until index decreasing conditions are met.

If index decreasing conditions are met (block 16), EGR is again ON and index value C is decremented by value Y (block 18). A check of the presence of index decreasing conditions is repeated (block 20) and, if this check is negative, a further check (block 22) is made to verify if index C is still above a critical threshold CCritic.

If this is the case, the EGR is OFF (block 14) and the index value C is kept at the same value until index decreasing conditions are met and the steps of blocks 16,18,20 and 22 are repeated.

If index C decreasing conditions are not met anymore and index C is below the critical index threshold CCritic, the EGR is ON and the index C is kept at the same value (block 24), until increasing index conditions are met (block 26).

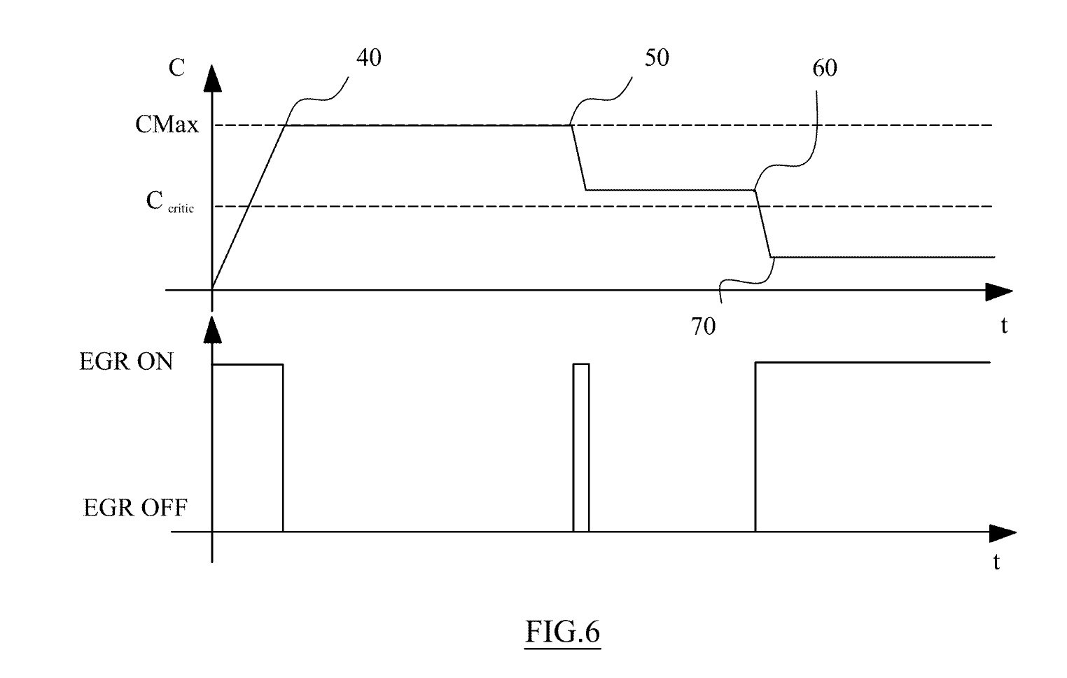

FIG. 6 is a graph representative of exemplary EGR events determined according to an embodiment.

In this example, at the beginning of the procedure, EGR is ON and the index value C is increased. That may happen, for example, because the EGR coolant has been at a low temperature during a certain amount of time of driving.

When the index value C reaches a clogging threshold CMax (point 40), the EGR valve 320 is closed or the EGR cooler 310 is by-passed.

If the conditions to decrease the index value C are all fulfilled, the EGR valve 320 is opened or the EGR cooler 310 is no more bypassed (point 50).

If the conditions to decrease the index value C are no more fulfilled but the index value C is still in the critical range, namely has still a value higher than the critical index threshold CCritic, the EGR valve 320 is closed or the EGR cooler 310 is bypassed (point 60).

If the conditions to decrease the index are no more fulfilled, but the index value C is lower than the critical index threshold CCritic, the EGR valve 320 can be kept opened or the EGR cooler 310 can be kept not bypassed (point 70).

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. A method for operating an EGR system in an Internal Combustion Engine (ICE), the EGR system comprising an EGR valve for regulating an exhaust gas flow into an EGR cooler, and a by-pass line for by-passing the EGR cooler, the method comprising the steps of:
monitoring an index value indicative of a clogging condition of the EGR cooler;
closing the exhaust gas flow in the EGR cooler if the index value exceeds a predefined threshold; and
opening the exhaust gas flow in the EGR cooler if the index value is decreasing.

2. The method according to claim 1, wherein closing the exhaust gas flow in the EGR cooler is actuated by closing the EGR valve.

3. The method according to claim 1, wherein closing the exhaust gas flow in the EGR cooler is actuated by by-passing the EGR cooler.

4. The method according to claim 3, wherein the index value is incremented by an index increasing value when the following conditions are met:
an engine load is lower than a load threshold dependent on engine speed and engine coolant temperature;
the engine coolant temperature is lower than a threshold, or an engine thermostatic valve is closed, or a coolant temperature in the EGR cooler is estimated to be lower than a threshold;
the EGR valve is open; and
the EGR cooler is not bypassed.

5. The method according to claim 3, wherein the index value is maintained at a constant value when one of the following conditions is met:
the ICE is stopped;
the EGR cooler is bypassed;
the EGR valve is closed, or
a combination thereof.

6. The method according to claim 3, wherein the index value is decreased by an index decreasing value when the following conditions are met:
the EGR valve is requested to be opened;
the EGR cooler is requested not to be bypassed;
and at least one of the following conditions is met:
an engine load is higher than a load threshold, dependent on engine speed and engine coolant temperature; and
the engine coolant temperature is higher than a threshold, or an engine thermostatic valve is open.

7. The method according to claim 6, in which the exhaust gas flow in the EGR cooler is closed if conditions to decrease the index value are no more fulfilled, but the index value is still higher than a critical index threshold.

8. The method according to claim 1, wherein if the index value is saturated to a predefined threshold value and the EGR valve is closed or the EGR cooler is bypassed for a time longer than a calibratable threshold visual and/or acoustic means are activated to signal a necessity to allow an EGR cooler regeneration.

9. An apparatus for operating an EGR system in an Internal Combustion Engine, the EGR system comprising an EGR valve for regulating an exhaust gas flow into an EGR cooler, and a by-pass line for by-passing the EGR cooler, the apparatus comprising:
means for monitoring an index indicative of a clogging condition of the EGR cooler;
means for closing the exhaust gas flow in the EGR cooler if an index value exceeds a predefined threshold; and
means for opening the exhaust gas flow in the EGR cooler if the index value is decreasing.

10. An automotive system comprising an internal combustion engine equipped with an EGR system, the EGR system comprising an EGR valve for regulating an exhaust gas flow into an EGR cooler, and a by-pass line for by-passing the EGR cooler, the automotive system comprising an electronic control unit configured for:
monitoring an index indicative of a clogging condition of the EGR cooler;
closing the exhaust gas flow in the EGR cooler if an index value exceeds a predefined threshold; and
opening the exhaust gas flow in the EGR cooler, if the index value is decreasing.

11. An internal combustion engine having associated sensors for measurement of combustion parameters, the internal combustion engine equipped with an EGR system, the EGR system comprising an EGR valve for regulating an exhaust gas flow into an EGR cooler and a by-pass line for by-passing the EGR cooler, the internal combustion engine comprising an Electronic Control Unit configured for carrying out the method comprising the steps of:
monitoring an index value indicative of a clogging condition of the EGR cooler;
closing the exhaust gas flow in the EGR cooler if the index value exceeds a predefined threshold; and
opening the exhaust gas flow in the EGR cooler if the index value is decreasing.

12. The internal combustion engine according to claim 11, wherein closing the exhaust gas flow in the EGR cooler is actuated by closing the EGR valve.

13. The internal combustion engine according to claim 11, wherein closing the exhaust gas flow in the EGR cooler is actuated by by-passing the EGR cooler.

14. The internal combustion engine according to claim 13, wherein the index value is incremented by an index increasing value when the following conditions are met:
an engine load is lower than a load threshold dependent on engine speed and engine coolant temperature;
the engine coolant temperature is lower than a threshold, or an engine thermostatic valve is closed, or a coolant temperature in the EGR cooler is estimated to be lower than a threshold;
the EGR valve is open; and
the EGR cooler is not bypassed.

15. The internal combustion engine according to claim 13, wherein the index value is maintained at a constant value when one of the following conditions is met:
the ICE is stopped;
the EGR cooler is bypassed;
the EGR valve is closed, or
a combination thereof.

16. The internal combustion engine according to claim 13, wherein the index value is decreased by an index decreasing value when the following conditions are met:
the EGR valve is requested to be opened;
the EGR cooler is requested not to be bypassed;
and at least one of the following conditions is met:
an engine load is higher than a load threshold, dependent on engine speed and engine coolant temperature; and
the engine coolant temperature is higher than a threshold, or an engine thermostatic valve is open.

17. The internal combustion engine according to claim 16, in which the exhaust gas flow in the EGR cooler is closed if conditions to decrease the index value are no more fulfilled, but the index value is still higher than a critical index threshold.

18. The internal combustion engine according to claim 11, wherein if the index value is saturated to a predefined threshold value and the EGR valve is closed or the EGR cooler is bypassed for a time longer than a calibratable threshold visual and/or acoustic means are activated to signal a necessity to allow an EGR cooler regeneration.

19. A computer program product comprising a computer readable program code adapted to be executed to implement a method for operating an EGR system in an Internal Combustion Engine (ICE), the EGR system comprising an EGR valve for regulating an exhaust gas flow into an EGR cooler, and a by-pass line for by-passing the EGR cooler, the method comprising the steps of:
monitoring an index value indicative of a clogging condition of the EGR cooler;
closing the exhaust gas flow in the EGR cooler if the index value exceeds a predefined threshold; and
opening the exhaust gas flow in the EGR cooler if the index value is decreasing.
